(19) United States
(12) Patent Application Publication
(10) Pub. No.: US 2021/0116793 A1
(43) Pub. Date: Apr. 22, 2021

(54) CARRYING BAG WITH A POWER RESERVOIR

(71) Applicant: Oxti Corporation, Taipei (TW)

(72) Inventor: Chih Feng HO, Taipei (TW)

(21) Appl. No.: 16/659,742

(22) Filed: Oct. 22, 2019

(51) Int. Cl. G03B 21/10; A45C 15/00; A45C 3/00; G03B 21/58

(52) U.S. Cl. CPC G03B 21/10; G03B 21/58; A45C 3/00; A45C 15/00

(57) ABSTRACT

A carrying bag includes a housing, a retractor attached to the housing, the retractor includes a curtain movable out of the housing at an outwardly opened and working position, and a projector is engaged in the rotary member. A battery is disposed in the housing and electrically connected to the projector. The housing includes a wireless charging device electrically connected to the battery. The projector includes a transceiver module having a wired transceiver and a wireless transceiver for receiving the information from the mobile device wirelessly. The housing includes a rotary member, and the projector is engaged in the rotary member.

### BACKGROUND OF THE INVENTION

### 1. Field of the Invention

The present invention relates to a package or carrying bag for receiving various objects, such as mobile devices, tablets, screens, laptops, notebooks, etc., and more particularly to a package or carrying bag for accommodating or receiving various objects, such as mobile devices, tablets, screens, laptops, notebooks, and/or a projector, including an improved structure or configuration for allowing various data or images or videos or information to be easily and quickly and readily shown or displayed with the projector of the carrying bag, and including an electric power source or power reservoir for energizing various electric facilities or appliances or the like.

### 2. Description of the Prior Art

Typical mobile devices, such as tablets, screens, laptops, notebooks, etc., may normally be accommodated or received or contained within a fold or package which comprises a base and a cover foldable relative to each other.

However, the fold or package may not be used for accommodating or receiving the other displayers or mobile devices or the like, and also may not be used for showing or displaying the data or images or videos or information of the mobile devices, tablets, screens, laptops, notebooks, or the like.

In addition, the fold or package may only be used for receiving or accommodating various batteries therein, but may not be used for energizing various electric facilities or appliances or the like.

The present invention has arisen to mitigate and/or obviate the afore-described disadvantages of the conventional carrying bag for mobile devices.

### SUMMARY OF THE INVENTION

The primary objective of the present invention is to provide a package or carrying bag for accommodating or receiving various objects, such as a projector, including an improved structure or configuration for allowing various data or images or videos or information to be easily and quickly and readily shown or displayed with the projector of the carrying bag.

The other objective of the present invention is to provide a package or carrying bag including an electric power source or power reservoir for energizing various electric facilities or appliances or the like.

In accordance with one aspect of the invention, there is provided a carrying bag comprising a housing, a retractor attached to the housing, the retractor including a curtain movable out of the housing at an outwardly opened and working position, a projector including a transceiver module for transmitting and receiving an information from a mobile device and for projecting the information from the mobile device, and a battery disposed in the housing and electrically connected to the projector and arranged for allowing various data or images or videos or information to be easily and quickly and readily shown or displayed with the projector of the carrying bag.

The housing includes a connector for electrically connecting to the mobile device with an electric wire. The connector is also electrically connected to the projector. The housing includes a coupler for electrically connecting to a power reservoir or the like, and the coupler is also electrically to the battery. The housing includes a socket or terminal for electrically coupling to the mobile device.

The housing includes a wireless charging device disposed in the housing and electrically connected to the battery for wirelessly charging various electrical facilities or appliances. The transceiver module of the projector includes a wired transceiver unit for receiving the information from the mobile device with an electric wire. The transceiver module of the projector includes a wireless transceiver for receiving the information from the mobile device wirelessly.

The housing includes a rotary member rotatably engaged in the housing, and the projector is engaged in the rotary member. The rotary member includes a cavity formed in the rotary member, and the projector is engaged in the cavity of the rotary member. The housing includes an upper wall, and a depression formed in the upper wall, the rotary member is engaged in the depression of the upper wall of the housing.

The housing includes a chamber formed in the housing and defined by a base wall and the upper wall, a cover panel extended from the base wall and foldable relative to the base wall and the upper wall, a lock device attached to the cover panel, and another lock member attached to the housing for engaging with the lock device of the cover panel and for coupling the cover panel to the housing.

The retractor includes a casing, and the curtain is foldably received and engaged in the casing and movable out of the casing at the outwardly opened and working position. The retractor includes a curtain rod attached to the curtain for pulling the curtain out of the housing at the outwardly opened and working position. The retractor includes at least one stay attached to the curtain rod with a pivot joint.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view illustrating the operation of a carrying bag with a projector in accordance with the present invention;

FIG. 2 is another perspective view similar to FIG. 1, illustrating the operation of the carrying bag with the projector;

FIG. 3 is a further perspective view illustrating the carrying bag in a folded and storing position;

FIG. 4 is a still further perspective view illustrating the carrying bag in an opened and working position;

FIG. 5 is a still further perspective view similar to FIG. 4, illustrating the other arrangement of the carrying bag;

FIGS. 6, 7 are still further perspective views similar to FIG. 4, illustrating the operation of the carrying bag;

FIG. 8 is a still further perspective view similar to FIGS. 4-7, illustrating the opening operation of the curtain of the retractor of the carrying bag; and

FIG. 9 is a block diagram illustrating the parts or elements of the carrying bag with the projector.

### DETAILED DESCRIPTION OF THE PREFERRED EMBODIMENT

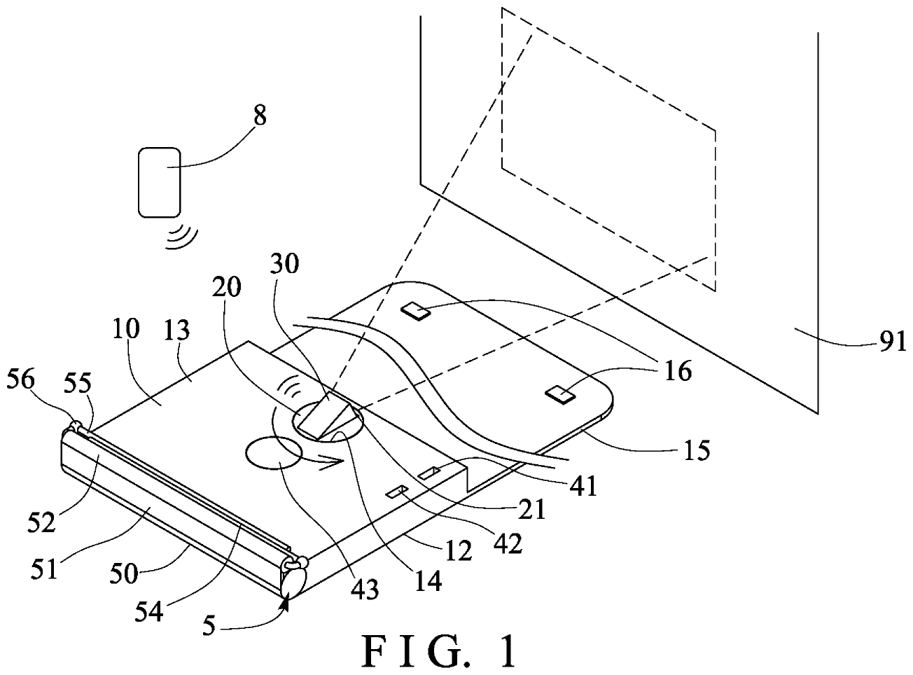

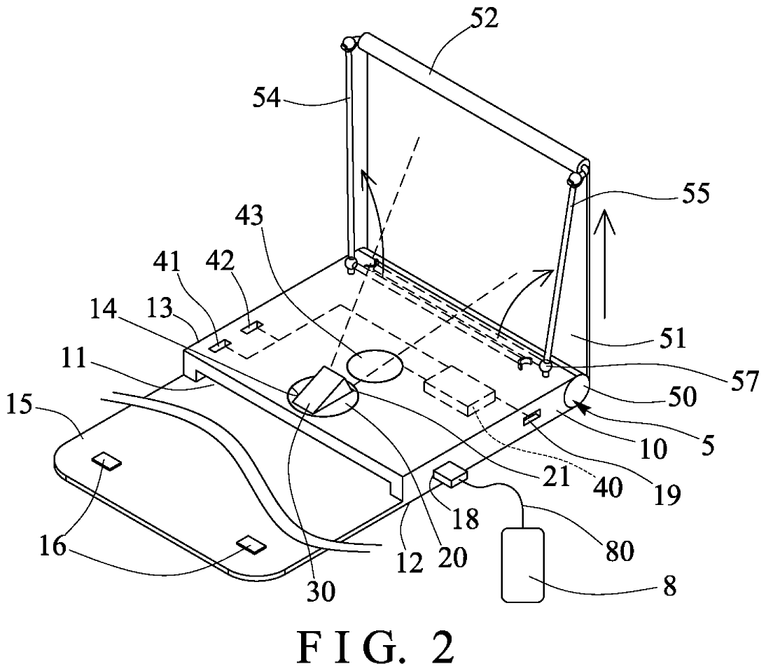

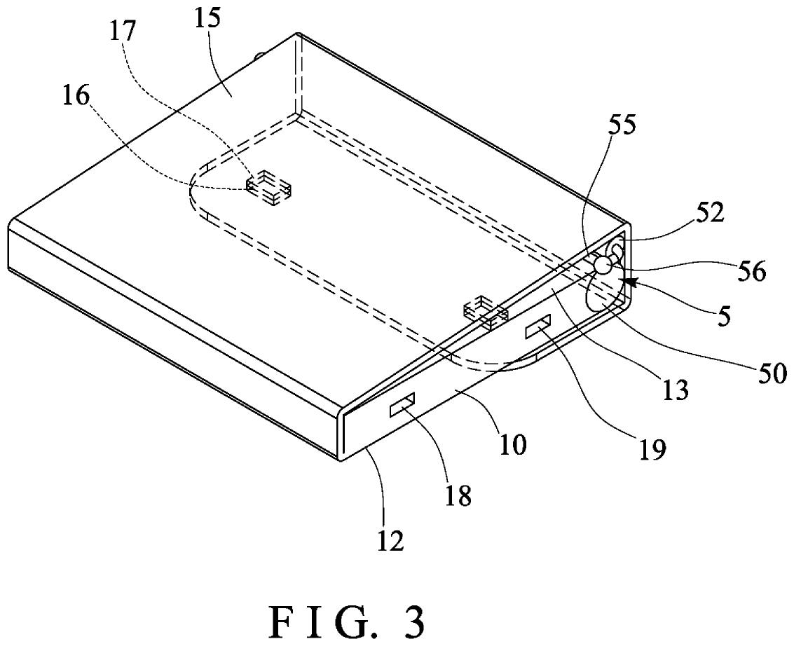

Referring to the drawings, and initially to FIGS. 1 and 2, a package or container or carrying bag with a projector in accordance with the present invention comprises a carrying bag body or housing 10 including a compartment or chamber 11 formed therein and formed or defined by a bottom or base wall 12 and an upper wall 13, and including a recess or depression 14 formed in the upper wall 13, the depression 14 that is formed in the upper wall 13 may be communicated with or spaced or separated from the chamber 11 of the housing 10. The housing 10 includes a cover panel 15 hinged or extended from the base wall 12 and foldable relative to the base wall 12 and/or the upper wall 13 and/or foldable or movable toward the upper wall 13 (FIG. 3) for covering or shielding the depression 14 of the upper wall 13 and/or the chamber 11 of the housing 10 selectively.

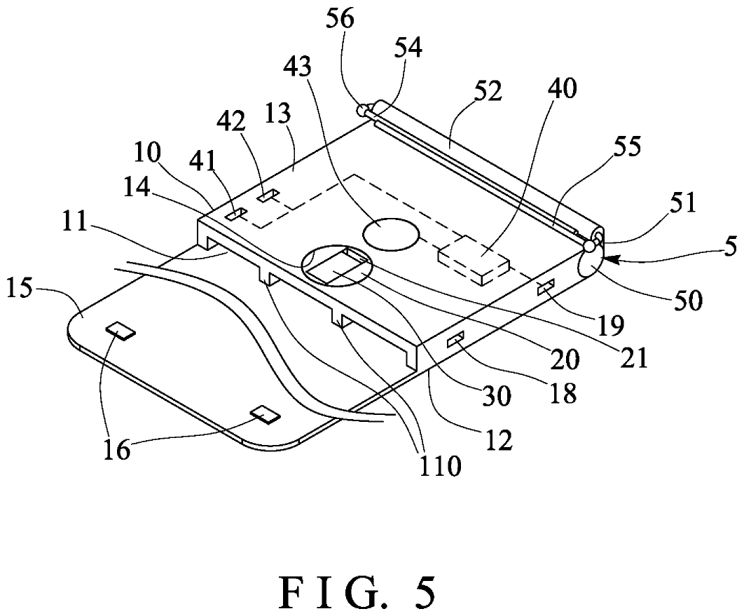

The housing 10 further includes a lock device 16 (FIGS. 1-8), such as a Velcro, a magic sticker or the like attached or mounted or secured to the cover panel 15. The housing 10 further includes another lock device or lock member 17 (FIG. 3), such as a Velcro, a magic sticker or the like attached or mounted or secured to the base wall 12, for selectively engaging with the lock device 16 of the cover panel 15, and for solidly and stably securing or coupling the cover panel 15 to the base wall 12 of the housing 10. The chamber 11 of the housing 10 may be provided for accommodating or receiving or containing a mobile device 8 (FIGS. 1-2), such as a tablet, a laptop, a screen, a displayer, a notebook, a portable phone, a mobile phone, or the like, and/or one or more electrical wires or cables 80, 81, 82 (FIGS. 2 and 6-7) or the like. As shown in FIG. 5, the housing 10 may further include one or more (such as two) spacers or partitions 110 engaged therein for spacing or separating the chamber 11 of the housing 10 into two or more smaller spaces and for accommodating or receiving various objects.

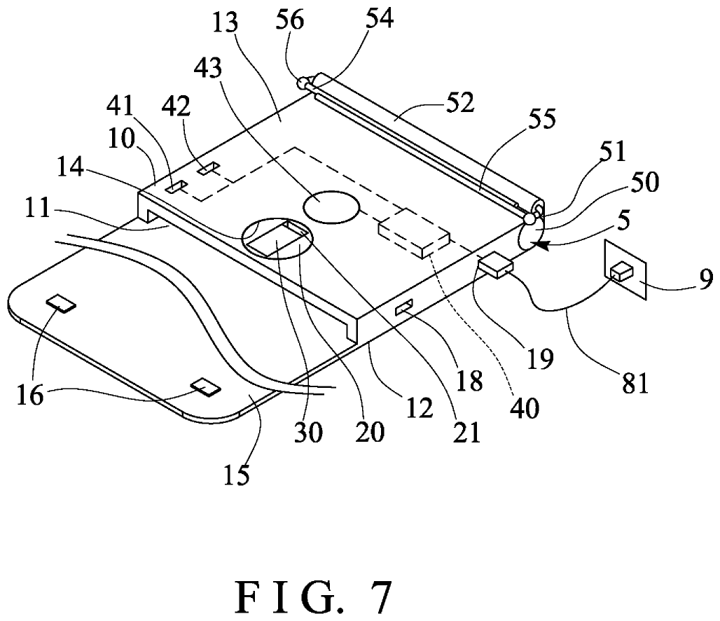

The housing 10 includes a socket or terminal or coupler or connector 18 formed or provided therein for selectively and electrically connected or coupled to the mobile device 8 (FIG. 2) with an electric wire or cable 80 and for receiving the data or images or videos or information from the mobile device 8 selectively, and includes another socket or terminal or connector or coupler 19 formed or provided therein for selectively and electrically connected or coupled to the power source or power reservoir 9 (FIG. 7) with another electric wire or cable 81 and for receiving the power source or power energy from the power source or power reservoir 9, and for energizing various electric facilities or appliances or the like.

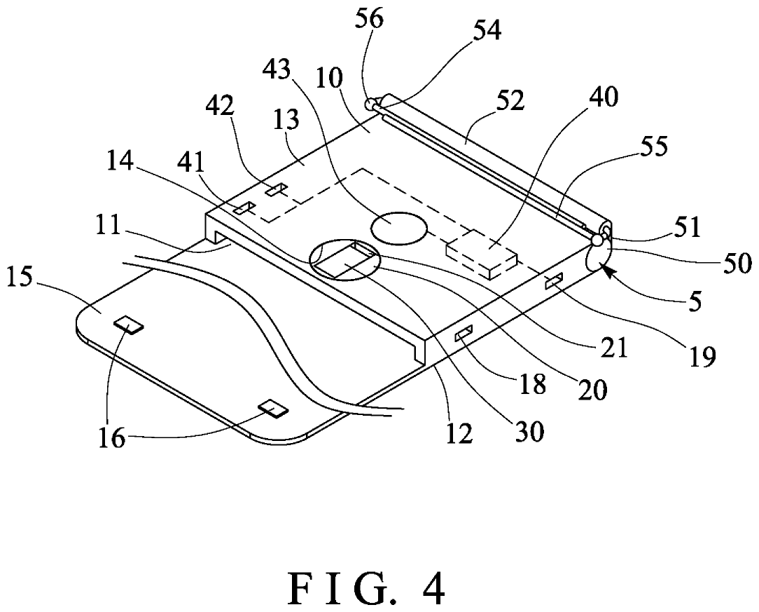

A pivotable or rotatable or rotary member 20 is pivotally or rotatably received or engaged in the depression 14 of the upper wall 13 and/or of the housing 10 and pivotable or rotatable relative to the housing 10, and includes a non-circular opening or cavity 21 formed therein, and a projecting device or projector 30 is pivotally or rotatably received or engaged in the cavity 21 of the rotary member 20 and pivotable or rotatable relative to the rotary member 20 and/or the housing 10 (FIGS. 1-2 and 4-8) for allowing the projector 30 to be selectively folded and received or engaged in the cavity 21 of the rotary member 20 at the folded and storing position (FIGS. 4-7), and at the outwardly opened or working position (FIGS. 1-2 and 8) for outwardly projecting purposes. It is to be noted that, without the rotary member 20, the projector 30 may also be directly and pivotally or rotatably received or engaged in the depression 14 of the upper wall 13 and/or of the housing 10 and pivotable or rotatable relative to the housing 10.

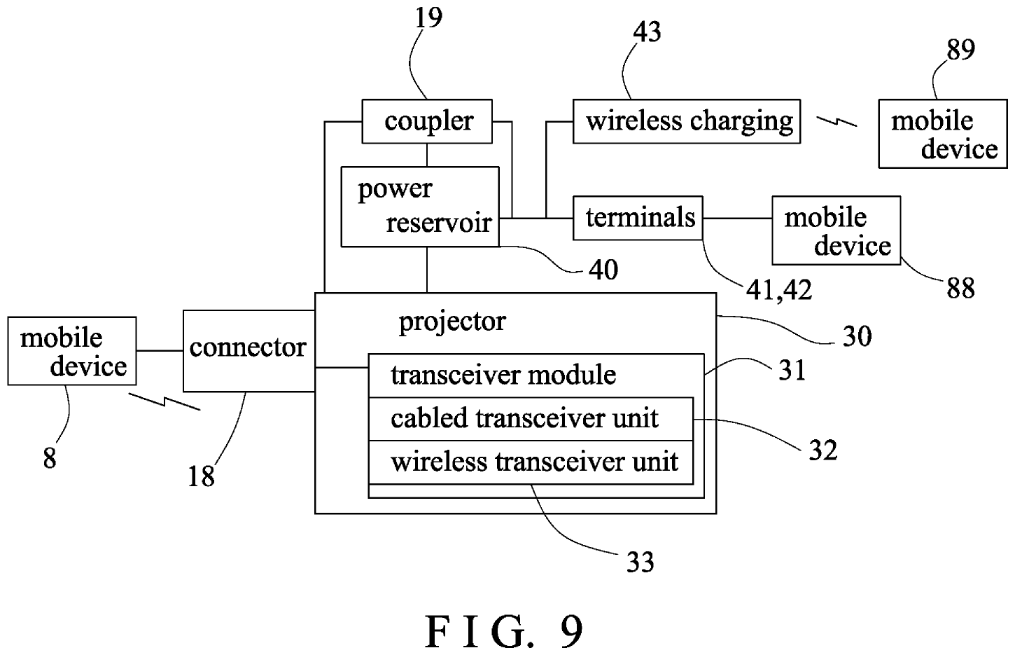

As shown in FIG. 9, the projector 30 is electrically connected or coupled to the connector 18, and includes a transmitting and receiving module or transceiver module 31 having a wired or cabled transmitting and receiving unit or transceiver unit 32 and a wireless transmitting and receiving unit or transceiver unit 33 for transmitting and/or receiving the data or images or videos or information from the mobile device 8 selectively with the electric wire or cable 80 (FIG. 2) and/or wirelessly (FIG. 1), and for allowing the data or images or videos or information from the mobile device 8 to be easily and quickly and readily shown or displayed with the projector 30 selectively (FIGS. 1-2). The projector 30 may also be powered or energized with or by the power source or power reservoir 9 and/or the batteries 40 received or engaged in the housing 10.

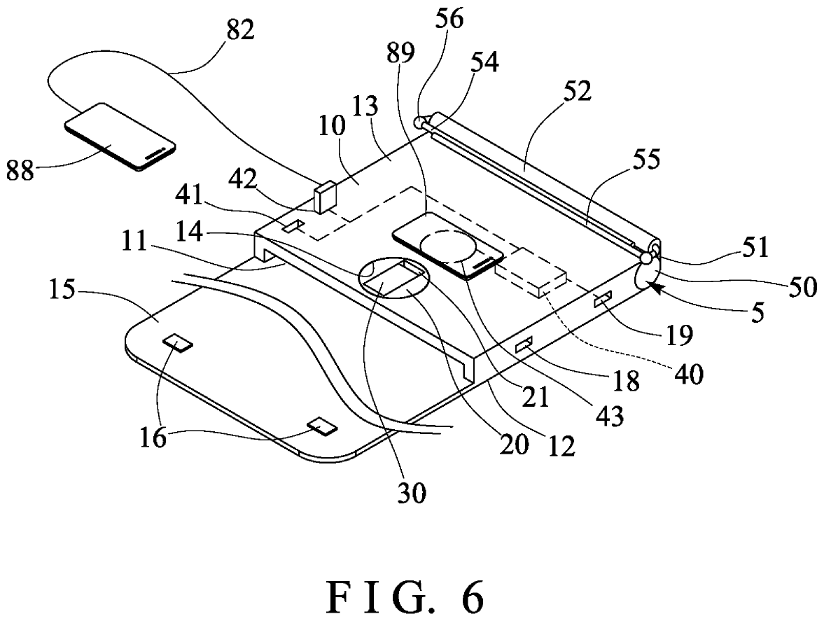

As shown in FIGS. 2 and 6-9, the batteries 40 are electrically connected or coupled to the coupler 19 which may be electrically connected or coupled to the power reservoir 9 (FIG. 7) with the electric wire or cable 81 and for receiving the power source or power energy from the power source or power reservoir 9, and for storing the power source or power energy in the batteries 40. The housing 10 further includes one or more (such as two) sockets or terminals 41, 42 for electrically connecting or coupling to the mobile device 88 (FIGS. 6 and 9) with an electric wire or cable 88 and for energizing the mobile device 88 selectively. The housing 10 may further includes a wireless charging device 43 electrically connected or coupled to the batteries 40 for supplying the electric power or energy to the batteries 40 selectively, and for energizing the mobile device 89 (FIGS. 6 and 9) selectively.

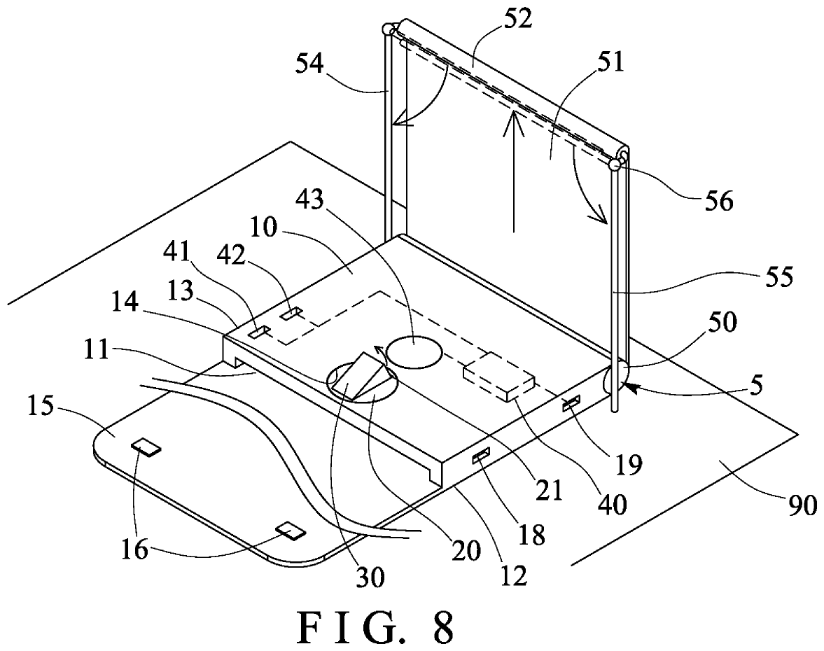

The housing 10 may further include a retractor 5 disposed or engaged therein, or attached to the housing 10, and located distal to the rotary member 20 and/or the projector 30, and for example, the retractor 5 includes a cylindrical member or casing 50 disposed or engaged in the housing 10 and located distal to the rotary member 20 and/or the projector 30, and a cloth screen or curtain 51 foldably received or engaged in the casing 50 and arranged for allowing the curtain 51 to be selectively folded and received or engaged in the casing 50 at the folded and storing position (FIGS. 1 and 3-7), and/or at the outwardly opened or working position (FIGS. 2 and 8).

For example, the retractor 5 includes a beam or lever or curtain rod 52 attached or mounted or secured to the outer edge of the curtain 51 for selectively pulling the curtain 51 out of the casing 50 at the outwardly opened or working position.

It is preferable that the retractor 5 further includes one or more (such as two) legs or stays 54, 55 pivotally or rotatably attached or mounted or secured to the curtain rod 52 with hinges or pivot joints 56 (FIGS. 1 and 3-8), and arranged for allowing the stays 54, 55 to be selectively folded toward and engaged with the curtain rod 52 at the folded and storing position (FIGS. 1 and 3-7), and/or at the outwardly opened or working position (FIG. 8) where the stays 54, 55 may be selectively contacted or engaged with the ground or the supporting surface 90 (FIG. 8) for supporting the curtain 51 at the outwardly opened or working position. Alternatively, as shown in FIG. 2, the stays 54, 55 may also be selectively and pivotally or rotatably attached or mounted or secured to the housing 10 with hinges or pivot joints 57 and arranged for allowing the stays 54, 55 to be selectively folded relative to the housing 10 at the folded and storing position as shown in the dotted lines in FIG. 2.

In operation, as shown in FIG. 2, the mobile device 8 may be selectively and electrically connected or coupled to the connector 18 of the housing 10 for transmitting and/or receiving the data or images or videos or information to and from the projector 30, or the projector 30 may transmit and/or receive the data or images or videos or information to and from the mobile device 8 wirelessly (FIG. 1) for allowing the data or images or videos or information from the mobile device 8 to be easily and quickly and readily shown or displayed with the projector 30 selectively (FIGS. 1-2). As shown in FIG. 3, when the curtain 51 is pulled or moved out of the casing 50 at the outwardly opened or working position, the projector 30 may display and project the data or images or videos or information from the mobile device 8 to the curtain 51 selectively.

As shown in FIG. 2, the projector 30 may also display and project the data or images or videos or information from the mobile device 8 to the wall 91 selectively. The projector 30 and/or the rotary member 20 may be pivoted or rotated relative to the housing 10 to any suitable or selected or predetermined or required angular position or location for suitably displaying and projecting the data or images or videos or information from the mobile device 8 to any suitable or selected or predetermined or required walls or objects or the like. It is to be noted that typical packages or carrying bags may have no projecting device or projector disposed or accommodated or received therein, and may have no curtain provided for showing or displaying various data or images or videos or information from the projector.

Accordingly, the package or carrying bag for mobile device in accordance with the present invention includes an improved structure or configuration for allowing various data or images or videos or information to be easily and quickly and readily shown or displayed with the projector of the carrying bag, and includes an electric power source or power reservoir for energizing various electric facilities or appliances or the like.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A carrying bag comprising:
a housing,
a retractor attached to said housing, said retractor including a curtain movable out of said housing at an outwardly opened and working position,
a projector including a transceiver module for transmitting and receiving an information from a mobile device and for projecting the information from said mobile device, and
a battery disposed in said housing and electrically connected to said projector.

2. The carrying bag as claimed in claim 1, wherein said housing includes a connector for electrically connecting to said mobile device with an electric wire.

3. The carrying bag as claimed in claim 2, wherein said connector is electrically connected to said projector.

4. The carrying bag as claimed in claim 1, wherein said housing includes a coupler for electrically connecting to a power reservoir, said coupler is electrically to said battery.

5. The carrying bag as claimed in claim 1, wherein said housing includes a terminal for electrically coupling to said mobile device.

6. The carrying bag as claimed in claim 1, wherein said housing includes a wireless charging device disposed in said housing and electrically connected to said battery.

7. The carrying bag as claimed in claim 1, wherein said transceiver module of said projector includes a wired transceiver unit for receiving the information from said mobile device with an electric wire.

8. The carrying bag as claimed in claim 1, wherein said transceiver module of said projector includes a wireless transceiver for receiving the information from said mobile device wirelessly.

9. The carrying bag as claimed in claim 1, wherein said housing includes a rotary member rotatably engaged in said housing, and said projector is engaged in said rotary member.

10. The carrying bag as claimed in claim 9, wherein said rotary member includes a cavity formed in said rotary member, and said projector is engaged in said cavity of said rotary member.

11. The carrying bag as claimed in claim 9, wherein said housing includes an upper wall, and a depression formed in said upper wall, said rotary member is engaged in said depression of said upper wall of said housing.

12. The carrying bag as claimed in claim 11, wherein said housing includes a chamber formed in said housing and defined by a base wall and said upper wall, a cover panel extended from said base wall and foldable relative to said base wall and said upper wall, a lock device attached to said cover panel, and a lock member attached to said housing for engaging with said lock device of said cover panel and for coupling said cover panel to said housing.

13. The carrying bag as claimed in claim 1, wherein said retractor includes a casing, and said curtain is foldably received and engaged in said casing and movable out of said casing at the outwardly opened and working position.

14. The carrying bag as claimed in claim 1, wherein said retractor includes a curtain rod attached to said curtain for pulling said curtain out of said housing at the outwardly opened and working position.

15. The carrying bag as claimed in claim 14, wherein said retractor includes at least one stay attached to said curtain rod with a pivot joint.
